(19) United States
(12) Patent Application Publication
(10) Pub. No.: US 2013/0069267 A1
(43) Pub. Date: Mar. 21, 2013

(54) Method And Apparatus For Forming Color Swirls In Plastic Containers

(71) Applicants: Wei Liu, Pittsburgh, PA (US); Lee M. Nicholson, Katonah, NY (US); Francis M. Schloss, Perrysburg, OH (US); Christopher W. White, Toledo, OH (US)

(72) Inventors: Wei Liu, Pittsburgh, PA (US); Lee M. Nicholson, Katonah, NY (US); Francis M. Schloss, Perrysburg, OH (US); Christopher W. White, Toledo, OH (US)

(73) Assignee: PepsiCo, Inc., Purchase, NY (US)

(21) Appl. No.: 13/234,896

(22) Filed: Sep. 16, 2011

(51) Int. Cl. B29C 45/16; B29C 49/00

(52) U.S. Cl. 264/73

(57) ABSTRACT

Single or multiple colorants are infused into a thermoplastic material during melt processing to form preforms and plastic containers exhibiting a marbleized or swirl-type pattern. A base resin and colorant may be fed into an extruder having an extrusion screw and/or barrel modified in a manner to cause incomplete and non-uniform mixing. The modifications may include notches in some of the flights along the extrusion screw, a reduction in the depth or omission of some of the flights, a reduction in diameter of the extrusion screw, or the provision of a marbleizing torpedo near the discharge nozzle. Other techniques include introducing the colorant into vents present along the barrel, using a barrier screw to keep the components separate along the length of the barrel, using a high pressure pump for introducing the colorant near the discharge nozzle, or using multi-material co-injection techniques for co-injecting the base resin and colorant.

### BACKGROUND

Current polyethylene terephthalate (PET) containers often are clear or uniformly shaded with minimum amount of color (color-pigments, effects pigments, dyes). Some techniques have been proposed to prepare multi-colored preforms and containers, generally involving the formation of two or more discrete colored regions. For example, Dierickx U.S. 2010/0307633 A1 describes a blow molded polychromatic container having a seamless and uninterrupted transition between primary and secondary materials. Abe et al. U.S. 2008/0317989 A1 discloses an injection molded bottle having an embedded colored layer which exhibits a gradual decrease in thickness to achieve a similar visual effect.

It would be desirable to make containers, such as PET beverage containers, with improved and unique visual characteristics, especially containers that may be prepared using injection blow molding techniques while requiring only minimal modifications to existing equipment.

### SUMMARY

In one aspect, a method is provided for infusing single or multiple colorants into a thermoplastic material during melt processing to form plastic containers exhibiting a marbleized or swirl-type pattern. A base resin, such as PET, has one or more colorants non-uniformly distributed therein. In some embodiments, the base resin and colorant(s) are fed into an extruder having an extrusion screw disposed within a barrel. The extrusion screw, the barrel, or both are modified in such manner that the base resin and colorant(s) are mixed incompletely and non-uniformly. In one embodiment, notches are provided in at least some of the flights along the extrusion screw to achieve incomplete mixing. In other embodiments, the depth of at least some of the flights is reduced, or some of the flights may be omitted altogether. Alternatively, an extrusion screw with a thinner diameter may be used to achieve less complete mixing. In yet other embodiments, a marbleizing torpedo is provided near the barrel discharge. The base resin and colorant(s) are conveyed to the torpedo with relatively little mixing and just enough compaction to initiate melting.

The heterogeneous mixture may be heated to a molten state and fed through an extrusion nozzle to form an extrudate. The extrudate may be then injection molded to form a preform having a marbleized or swirl-type pattern. The preform may be subsequently blow molded into a container having a similar or corresponding marbleized or swirl-type pattern.

In other embodiments, the base resin and the colorant(s) are introduced or maintained in an extruder separately to achieve incomplete and non-uniform mixing. In one embodiment, for example, the colorant(s) is introduced into vents or other openings present in one or more zones along the barrel. In another embodiment, a barrier screw is used for melting the base resin and colorant(s) while keeping the components separate based on differences in melt temperature and/or melt viscosity. In another embodiment, a high pressure pump is used for introducing the colorant(s) between the nozzle of the extruder and a hot runner. In yet another embodiment, multi-material co-injection techniques are used for injecting the base resin and colorant(s) into a single barrel, single screw extruder.

The resulting containers have aesthetically pleasing marbleized or swirl-type patterns, which may provide enhanced shelf presence as well as favorably influence consumer purchasing intent. In general, the patterns are randomized, unique, and essentially non-repeatable.

### BRIEF DESCRIPTION OF THE DRAWINGS

FIG. 1 schematically illustrates a barrel and screw configuration for extruding a thermoplastic resin material.

FIG. 2 shows an example of an extrusion screw having notched flights in the final mixing zone.

FIG. 3 shows an example of an extrusion screw with flights removed in the final mixing zone.

FIG. 4 schematically illustrates an extrusion barrel having a marbleizing torpedo near the discharge end thereof.

FIG. 5 is a schematic illustration of an extrusion barrel having one or more vents through which colorant(s) may be introduced.

FIG. 6 schematically illustrates an extrusion barrel having a high pressure pump for introducing a colorant between the discharge nozzle and a hot runner.

FIG. 7 schematically illustrates an extrusion screw and barrel where the base resin and colorant are co-injected in a single shot.

### DETAILED DESCRIPTION

The invention is described primarily with reference to preparing injection-molded preforms, which are blow-molded into beverage containers. It should be recognized, however, that the techniques described herein may be used in the preparation of other types of containers, such as jars, tubs, trays, or bottles for holding foodstuffs or liquid. A variety of thermoplastic materials may be used as the base resin, alone or in combination with other thermoplastic materials, non-limiting examples of which include polyethylene terephthalate (PET) or other thermoplastic polyesters such as polyethylene 2,6- and 1,5-naphthalate (PEN), PETG, polytetramethylene 1,2-dioxybenzoate, and copolymers of ethylene terephthalate and ethylene isophthalate; polyolefins such as polypropylene and polyethylene, as well as other materials derived from petroleum such as polystyrene, and the like. Of these, PET is most commonly used. The polymeric materials may include, in whole or in part, virgin polyester, recycled polyester, and/or co-polyesters, with or without conventional additives such as mold release agents and the like.

In general, preforms as described herein may be prepared by extruding at least one thermoplastic material to form an extrudate, which is thereafter injection-molded into a shape similar to a test tube. The preform is subsequently stretched and blow-molded to form a container using well known techniques. The thermoplastic material contains a base resin and at least one colorant non-uniformly distributed therein. The base resin may be clear or may contain one or more colorants. While the invention is described primarily with reference to mono-layer preforms and containers, it should be recognized that the invention is not so limited, as one or more additional layers also may be present, including functional layers such as gas barrier layers or the like.

Swirls of color and/or a marbleized appearance may be created in plastic containers using monolayer injection extrusion molding in accordance with one or more aspects as described herein. In some aspects, such visual effects are achieved by causing incomplete or “poor” mixing of one or more colorants in a base resin during melt processing. Such incomplete mixing of the components (sometimes referred to herein as forming a heterogeneous mixture) may be aided where the melt viscosity, melt temperature, and/or other properties of the colorant(s) are dissimilar to those of the base resin.

In general, the colorant(s) should melt thoroughly and undergo incomplete mixing with the base resin to provide the intended visual effects. Some of the process conditions which be adjusted to achieve the desired effects include: screw speed, back pressure, barrel temperature, and cushion (volume of material in front of the screw). By achieving an appropriate but incomplete level of mixing of the colorant(s) and base resin, the resulting blow molded preforms and containers may exhibit the desired marbleized or swirl-type patterns.

A variety of colorants, e.g., pigments, dyes, or the like, may be used. Colorants may be used alone or in combination with other colorants to introduce marbleized or swirl-type patterns as described herein. In general, colorants should be selected and used in loadings that are compatible with processing of the thermoplastic material. Non-limiting examples of colorants include transparent blue: Solid PET Masterbatch colorant (Penn Color #66S 2484); white: Solid PET Masterbatch colorant (PolyOne Color #CC10084837WE); cyan: Solid PET Masterbatch colorant (Penn Color #66S 2485); transparent green: liquid colorant (ColorMatrix #184-10223-1); and opaque green: Solid PET Masterbatch (Ampacet Color #774266). These materials are merely given by way of example, as a wide variety of colorants conventionally used for plastics may be used without departing from the spirit or scope of the invention.

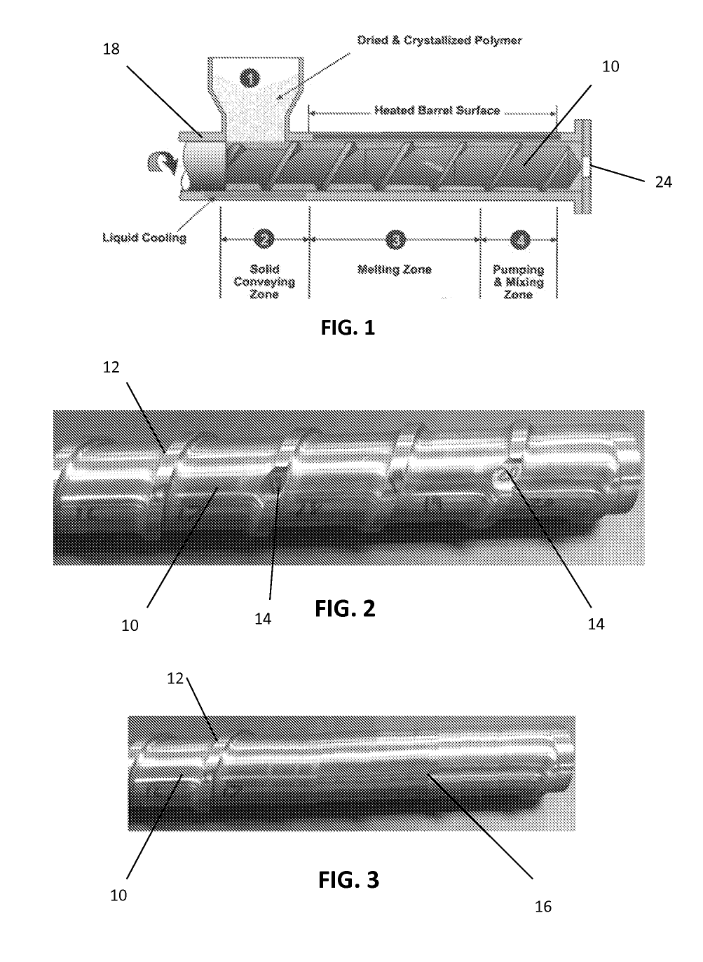

In some aspects, one or more zones of an extrusion screw/barrel configuration are modified to achieve incomplete or non-uniform mixing. FIG. 1 schematically illustrates a typical extrusion assembly, in which pre-dried and crystallized polymeric resin is introduced from a hopper 1 to the feed (or conveying) zone 2 of a barrel 18. An extrusion screw 10 within the barrel 18 rotates and forces the material down the length of the barrel 18 and eventually through a discharge nozzle 24. In a typical arrangement, the material is cooled while in the feed zone 2 and heated as it is conveyed through melting zone 3 and mixing (or metering) zone 4.

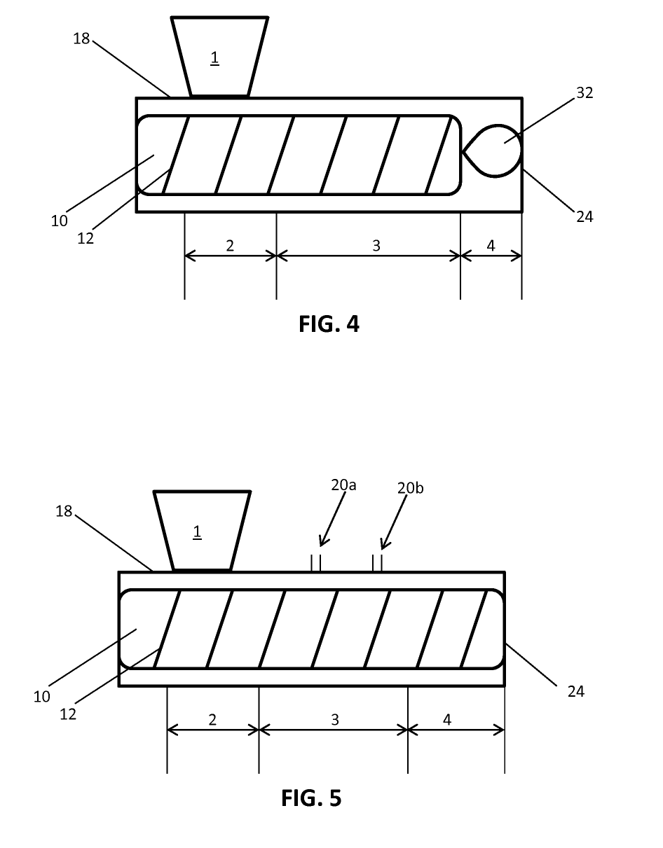

In general, melting of the resin occurs primarily in the melting or compression zone 3, while mixing occurs predominately in the mixing zone 4 (although mixing also typically occurs to some extent in the feed zone 2 and/or melting zone 3). FIGS. 2 and 3 illustrate extrusion screws having flights 12 which are modified to be less effective or less efficient, particularly in the mixing zone 4. In the case of FIG. 2, notches 14 are formed in flights 12 at or near the distal end of the screw 10. The notches 14 are configured to interrupt or partially interfere with mixing that normally occurs in the mixing zone 4. The notched flights generally reduce or minimize the amount of compression, although some compression will be needed to melt the material before the mixing zone 4. Also, additional melt residence time may be needed to compensate for the reduction in shear heating associated with this reduced compression.

As an alternative to forming notches 14 to interrupt complete mixing, the depth of some of the flights 12 may be reduced, typically those in the mixing zone 4. The depth of the flights 12 may be reduced partially, for example from about 10 to 90%, or from about 25 to about 50%. In one embodiment, as illustrated in FIG. 3, the flights are completely omitted in the mixing zone 4. The extent to which the flight depth is reduced can be appropriately selected depending on the properties of the base resin and colorant(s), such as melt viscosity, melting temperature, etc., and in accordance with achieving the desired visual effects, e.g., intensity and/or frequency of swirls, etc.

In another embodiment, a reduced diameter extrusion screw (not illustrated) may be used to achieve less complete mixing between the base resin and colorant(s). In a conventional extrusion screw/barrel design, the outer diameter of the screw is approximately equal to the inner diameter of the barrel (see, e.g., FIG. 1). In this embodiment, the outer diameter of the screw may be reduced, for instance such that the outer diameter is about 50 to about 90%, or in some cases from about 60 to about 80%, of the inner diameter of the barrel. By reducing the diameter of the screw, the extent of mixing may be reduced so that the colorant(s) is non-uniformly distributed in the base resin to achieve the desired marbleized or swirl-type pattern.

Another technique that may be used for producing a marbleized/swirl appearance is through the use of a screw and barrel that includes a torpedo section near the discharge or nozzle of the barrel. As schematically illustrated in FIG. 4, for example, a barrel 18 may have a screw 10 which conveys the material to a torpedo 32 positioned near the discharge nozzle 24, with very little mixing and just enough compaction to initiate melting. The material is then forced through the torpedo section 4, which is effectively a restriction in the barrel, where shear and melting occur with only minimal mixing. The material is then discharged through the nozzle 24, with the colorant(s) non-uniformly distributed in the base resin to achieve the marbleized or swirl-type pattern as described herein.

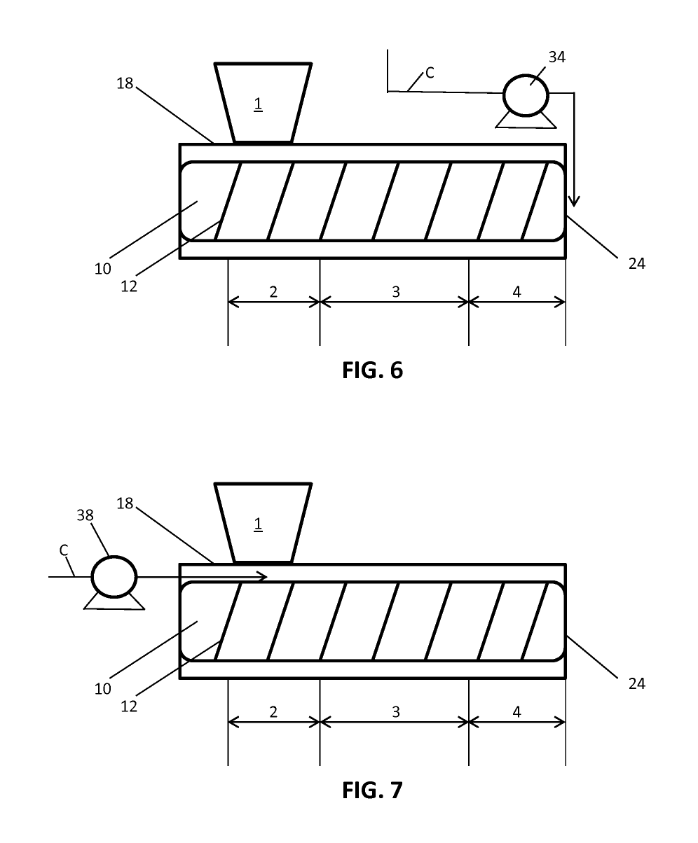

In yet another embodiment, a multi-stage screw with a vented barrel may be used to introduce one or more colorants as the material is conveyed through the barrel. As schematically shown in FIG. 5, a barrel 18 may include one or more openings 20a and 20b, such as vents that are conventionally used for exhausting water vapor and other gases from the barrel 18. Such openings 20a and 20b generally may be used for feeding additives into the polymer melt under low pressure conditions. The vented barrel 18 typically is used with a two-stage screw that includes a decompression zone 3 that corresponds to the location of the opening(s) 20a and 20b in the barrel 18. The first stage 2 of the screw includes a feed, compression, and metering zone. The second stage includes the decompression zone 3 followed by a short compression zone and a final metering zone 4.

In another embodiment, a barrier screw (not illustrated) may be used for thoroughly melting and keeping separate the base resin and colorant(s) based on differences in physical properties such as melting temperature and/or melt viscosity. The components are kept separate within the extrusion barrel during melting, and then combined near the discharge end of the barrel non-uniformly such that the colorant(s) produces a marbleized pattern or color swirls in the base resin. A non-limiting example of a barrier screw configuration that may be used is illustrated in Katsuno U.S. Pat. No. 5,356,281, the disclosure of which is hereby incorporated by reference.

In yet another embodiment, as schematically illustrated in FIG. 6, a high pressure pump 34 may be used to inject a liquid colorant(s) C between the nozzle 24 of the injection unit and the hot runner (not illustrated) of the injection molding device. The high pressure of the liquid colorant results in some mixing, such that the colorant is non-uniformly distributed in the polymer melt to achieve the marbleized or swirl-type pattern described herein upon injection molding the polymer melt.

Another technique which may be used is co-injection multi-material molding, as schematically shown in FIG. 7. This technique enables an extruder having a single barrel 18 and a single screw 10 to have two materials co-injected in a single shot with one material enclosing the other. As shown in FIG. 7, an injector 38 co-injects the base resin 1 and the colorant C into the barrel 18. An example of a commercially available device that may be used for co-injection multi-material molding is TWINSHOT®, available from Xaloy.

When employing either a high pressure pump (FIG. 6) or co-injection multi-material molding (FIG. 7), conditions such as the amount and/or rate of colorant injection, screw speed, and barrel temperature may be appropriately selected to achieve the desired marbleized or swirl-type patterns.

Upon blow molding the resulting preforms into containers, the marbleized or swirl-type patterns present in a preform typically will be manifested in the resulting container. However, because of changes in thickness or other physical properties that occur during blow molding, in some cases there may be variation between the pattern(s) present on the preform and those on the blow molded container.

The foregoing description should be considered illustrative rather than limiting. It should be recognized that various modifications can be made without departing from the spirit or scope of the invention as described and claimed herein.

1. A method of preparing a preform having a marbleized or swirl-type pattern, the method comprising:
feeding a base resin and at least one colorant into an extruder having an extrusion screw disposed within a barrel, wherein the extrusion screw has a plurality of flights along its length, and wherein notches are provided in at least some of the flights to achieve incomplete and non-uniform mixing of the base resin and the at least one colorant to form a heterogeneous mixture;
heating the heterogeneous mixture under sufficient temperature and pressure conditions to achieve a molten state; and
injection molding the heterogeneous mixture to form a preform, whereby the preform has a marbleized or swirl-type pattern.

2. (canceled)

3. A method of preparing a preform having a marbleized or swirl-type pattern, the method comprising:
feeding a base resin and at least one colorant into an extruder having an extrusion screw disposed within a barrel, wherein the extrusion screw has a plurality of flights along its length, and wherein the depth of at least some of the flights is reduced to achieve incomplete and non-uniform mixing of the base resin and the at least one colorant to form a heterogeneous mixture;
heating the heterogeneous mixture under sufficient temperature and pressure conditions to achieve a molten state; and
injection molding the heterogeneous mixture to form a preform, whereby the preform has a marbleized or swirl-type pattern.

4. The method of claim 3, wherein the depth of the flights is reduced from about 10 to about 90%.

5. The method of claim 3, wherein the depth of the flights is reduced from about 25 to about 50%.

6. The method of claim 1, wherein at least a portion of the flights is omitted.

7. The method of claim 3, wherein the extrusion screw has an outer diameter which is about 50 to about 90% of the inner diameter of the barrel.

8. The method of claim 7, wherein the outer diameter of the extrusion screw is about 60 to about 80% of the inner diameter of the barrel.

9. (canceled)

10. The method of claim 1, wherein the base resin comprises polyethylene terephthalate.

11. The method of claim 1, wherein the at least one colorant comprises a pigment, a dye, or a combination thereof.

12. A method of preparing a container having a marbleized or swirl-type pattern, the method comprising blow molding a preform prepared by the method of claim 1.

13. A method of preparing a preform having a marbleized or swirl-type pattern, the method comprising:
feeding a base resin into an extruder having an extrusion screw disposed within a barrel, and heating the base resin under sufficient temperature and pressure conditions to achieve a molten state;
injecting at least one colorant into one or more vents or openings present along the length of the barrel and combining the at least one colorant with the base resin to form a heterogeneous mixture; and
injection molding the heterogeneous mixture to form a preform, whereby the preform has a marbleized or swirl-type pattern.

14. (canceled)

15. A method of preparing a preform having a marbleized or swirl-type pattern, the method comprising:
feeding a base resin and at least one colorant into an extruder to form a heterogeneous mixture, and heating the heterogeneous mixture under sufficient temperature and pressure conditions to achieve a molten state; and
injection molding the heterogeneous mixture to form a preform, whereby the preform has a marbleized or swirl-type pattern;
wherein the extrusion screw comprises a barrier screw adapted for separating the base resin and the at least one colorant based on differences in melt temperature, melt viscosity, or both.

16-17. (canceled)

18. The method of claim 13, wherein the base resin comprises polyethylene terephthalate.

19. The method of claim 13, wherein the at least one colorant comprises a pigment, a dye, or a combination thereof.

20. A method of preparing a container having a marbleized or swirl-type pattern, the method comprising blow molding a preform prepared by the method of claim 13.
